(19) United States
(12) Patent Application Publication
(10) Pub. No.: US 2026/0236307 A1
(43) Pub. Date: Aug. 13, 2026

(54) SYSTEM AND METHOD FOR MANAGING RESOURCE LOSS

(71) Applicant: The Toronto-Dominion Bank, Toronto (CA)

(72) Inventors: Mohit SHARMA, Toronto (CA); Hitesh BAJAJ, Duluth, GA (US); Jonathan Joseph PRENDERGAST, West Chester, PA (US); Milos DUNJIC, Oakville (CA); David Samuel TAX, Toronto (CA); Thomas Osman KELLY, Wenonah, NJ (US); Pranay Chander GUPTA, Toronto (CA); Kushank RASTOGI, Toronto (CA); Abhijit Singha HAZARI, Oakville (CA)

(73) Assignee: The Toronto-Dominion Bank, Toronto (CA)

(21) Appl. No.: 19/052,372

(22) Filed: Feb. 13, 2025

(51) Int. Cl. G06F 9/50

(52) U.S. Cl. CPC G06F 9/5027

(57) ABSTRACT

Methods and systems for managing resource loss associated with a computing operation are described. In one aspect a system or processor executes a method that includes receiving first data representing a first assignment of a first computing operation and obtaining one or more first operation parameters. The one or more first operation parameters are obtained by providing programming to a generative function, the programming being at least partially based on the first data; and receiving output from the generative function. The method may further include determining, based on the one or more first operation parameters, a first execution period for the first computing operation to be at least partially executed; and generating one or more first operation triggers. Some operations may be performed using artificial intelligence.

### TECHNICAL FIELD

The present application relates to managing resource loss and, more particularly, to a method and system for scheduling computing operations using generating functions or artificial intelligence to minimize or optimize resource loss.

### BACKGROUND

Computing operations are often associated with a resource loss. For example, the operation of updating a computer system may result in the computer system being in a non-operational state during the update. That is, the operation of updating the computer system may result in a resource loss wherein the resource corresponds to access to or use of the computer system. In another example, the operation of updating a computer system may result in some resources or programs in the computer system being inaccessible. In another example, a computing operation may result in a data transfer or resource transfer from a first computer system to a second computer system. In this example, subsequent to the computing operation, the first computer system may incur a resource loss corresponding to losing access to the transferred data or resource.

In some circumstances, a resource loss is unavoidable. For example, a computer system may require an update for security-related or performance-related reasons. In another example, completion of a computational task may require the transfer of data or a resource and there may be a condition that the data or resource remain unique or single-instance (perhaps for security-related reasons). In these circumstances, timing may be critical. For example, it may be undesirable for a computer system to undergo a system update that is expected to run for 24 hours if operation of or access to the computer system is required or expected to be required within 24 hours. In another example, it may be undesirable to transfer data or resources to another computer system if the same data or resources are required or expected to be required in the near future. In other circumstances, there may be consequences to performing a computing operation associated with a resource loss too late. For example, failing to update a computer system in time may result in increased susceptibility to network attacks that result in a greater resource loss such as a permanent or extended non-operational state of the computer system. In another example, failing to transfer data or resources from a first computer system to a second computer system in time may result in failure to complete a particular task that may in turn result in a greater resource loss.

Accordingly, there is need for a computer system that can schedule computing operations to manage, minimize, or optimize resource loss.

### BRIEF DESCRIPTION OF THE DRAWINGS

Embodiments are described in detail below, with reference to the following drawings:

FIG. 1 is a schematic operation diagram illustrating an operating environment of an example embodiment;

FIG. 2 is a high-level schematic diagram of an example computer system;

FIG. 3 is a simplified organization of software components stored in a memory;

FIG. 4 shows a flow chart showing operations performed by a computer system in optimizing resource loss associated with a computing operation; and

FIG. 5 shows another flow chart showing operations performed by a computer system in optimizing resource loss associated with a computing operation.

Like reference numerals are used in the drawings to denote like elements and features.

### DETAILED DESCRIPTION OF VARIOUS EMBODIMENTS

In aspect, the present application describes a computer system. The computer system comprises at least one processor and a memory coupled to the at least one processor and storing processor-executable instructions. When executed by the at least one processor, the instructions configure the at least one processor to: receive first data representing a first assignment of a first computing operation and obtain one or more first operation parameters. The one or more first operation parameters are obtained by providing programming to a generative function, the programming being at least partially based on the first data; and receiving output from the generative function. The instructions further configure the processor to determine, based on the one or more first operation parameters, a first execution period for the first computing operation to be at least partially executed; and generate one or more first operation triggers.

In some implementations, the one or more first operation parameters include a first loss function, the first loss function having a first time-based input variable.

In some implementations, determining the first execution period further comprises: determining a first resource loss by passing at least a first time in the first execution period to the first loss function; and determining that incurring the first resource loss results in a resource quantity exceeding a resource threshold.

In some implementations, determining the first execution period further comprises: determining a second computing operation associated with a second loss function; and determining the first execution period based on the second loss function.

In some implementations, the instructions further configure the processor to: trigger one of the one or more first operation triggers during the first execution period; and execute at least partially, in response to triggering the one of the one or more first operation triggers, the first computing operation.

In some implementations, the first computing operation is associated with a client device and the instructions further configure the processor to: trigger one of the one or more first operation triggers during the first execution period; and request from the client device, in response to triggering the one of the one or more first operation triggers, authorization to execute, at least partially, the first computing operation.

In some implementations, the first computing operation is associated with a client device and the instructions further configure the processor to: trigger, prior to the first execution period, one of the one or more first operation triggers; and send to the client device, in response to triggering the one of the one or more first operation triggers, a notification that the first computing operation is to be executed, at least partially, during the first execution period.

In some implementations, determining the first execution period further comprises determining a plurality of execution periods to execute, at least partially, the first computing operation, the first execution period being one of the plurality of execution periods.

In some implementations, the first computing operation is associated with an identifier and the instructions further configure the at least one processor to store, in a storage medium, at least one of the one or more first operation parameters.

In some implementations, the instructions further configure the at least one processor to: receive second data representing a second assignment of a second computing operations associated with the identifier; and identify one or more second operation parameters, at least one of the second operation parameters being identified by retrieving the at least one of the one or more first operation parameters.

In some implementations, the first computing operation is one of a series of computing operations and the instructions further configure the processor to determine, based on operation data associated with at least one of the series of computing operations, a next execution period for a next computing operation to be at least partially executed.

In another aspect, the present application describes a computer-implemented method. The computer-implemented method comprises: receiving first data representing a first assignment of a first computing operation; and obtaining one or more first operation parameters. The one or more first operation parameters are obtained by: providing programming to a generative function, the programming being at least partially based on the first data; and receiving output from the generative function. The computer-implemented method further comprises: determining, based on the one or more first operation parameters, a first execution period for the first computing operation to be at least partially executed; and generating one or more first operation triggers.

In some implementations, the one or more first operation parameters include a first loss function, the first loss function having a first time-based input variable.

In some implementations, determining the first execution period further comprises: determining a first resource loss by passing at least a first time in the first execution period to the first loss function; and determining that incurring the first resource loss results in a resource quantity exceeding a resource threshold.

In some implementations, determining the first execution period further comprises: determining a second computing operation associated with a second loss function; and determining the first execution period based on the second loss function.

In some implementations, determining the first execution period further comprises determining a plurality of execution periods to execute, at least partially, the first computing operation, the first execution period being one of the plurality of execution periods.

In some implementations, the first computing operation is associated with an identifier and the method further comprises storing, in a storage medium, at least one of the one or more first operation parameters.

In some implementations, the method further comprises: receiving second data representing a second assignment of a second computing operations associated with the identifier; and identifying one or more second operation parameters, at least one of the second operation parameters being identified by retrieving the at least one of the one or more first operation parameters.

In some implementations, the first computing operation is one of a series of computing operations and the method further comprises determining, based on operation data associated with at least one of the series of computing operations, a next execution period for a next computing operation to be at least partially executed.

In another aspect, the present applications describes a non-transitory computer-readable storage medium comprising processor-executable instructions. When executed by at least one processor, the instructions configure the at least one processor to: receive first data representing a first assignment of a first computing operation; and obtain one or more first operation parameters. The one or more first operation parameters are obtained by: providing programming to a generative function, the programming being at least partially based on the first data; and receiving output from the generative function. The instructions further configure the processor to: determine, based on the one or more first operation parameters, a first execution period for the first computing operation to be at least partially executed; and generate one or more first operation triggers.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of . . . or . . . ” is intended to cover any one or more of the listed elements, including any one of the listed elements alone, any sub-combination, or all of the elements, without necessarily excluding any additional elements, and without necessarily requiring all of the elements.

In the present application, the term account or user account may be used interchangeably with “logical storage area” or “record” or “record in a database.”

In the present application, the terms “transferor” and “transferee” may be used interchangeably with “sender” and “recipient”, respectively, in the context of describing transfers of resources. In some cases, the terms “payor” or “payee” may be used in the example of monetary resources.

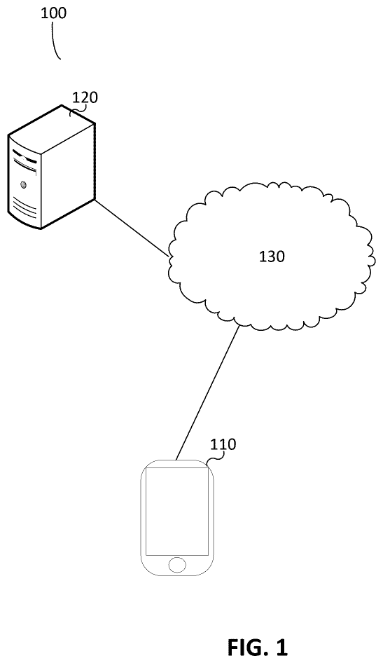

FIG. 1 is a block diagram illustrating an operating environment of an example embodiment. Various components cooperate to provide a system 100 which may be used, for example, to perform an operation. As shown, the system 100 may include a client system 110, a computer system 120, and a network 130 connecting the client system 110 and the computer system 120.

The client system 110 may be a mobile device as shown in FIG. 1. However, the client system 110 may be a computing device of another type such as for example, a laptop computer, a personal computer, a tablet computer, a notebook computer, a hand-held computer, a smart speaker, a personal digital assistant, a portable navigation device, a mobile phone, a wearable computing device (e.g., a smart watch, a wearable activity monitor, wearable smart jewelry, and glasses and other optical devices that include optical head-mounted displays), an embedded computing device (e.g., in communication with a smart textile or electronic fabric), and any other type of computing device that may be configured to store data and software instructions, and execute software instructions to perform operations consistent with disclosed embodiments. Furthermore, the client system 110 may comprise multiple computer devices or systems. For example, the client system 110 may include multiple computing devices organized in a tiered arrangement. Additionally or alternatively, the client system 110 may be a plurality of computer devices engaged in cloud computing.

The client system 110 may be related to a first computing operation or a resource management problem. For example, the client system 110 may be a computer system that is yet to receive or undergo a most recent security update. That is, the client system 110 may be due for a system update. In some embodiments, such a system update may cause the client system to be non-operational for an extended period of time (such as an hour or a day). In another example, the client system 110 may be involved in an operation that requires a data transfer or resource transfer from the client system 110 to another system (not explicitly shown in FIG. 1). In some embodiments relating to this example, there may be a condition that the data or resource to be transferred remain single-instance.

The client system 110 may be associated with an object. The object may be or include an entity, such as a person or business. The object may be or include a system, such as a server or other type of computing system. The object may be referred to as an accountholder or a logical storage area holder, in some implementations. The client system 110 may be associated with an object, such as an entity, that is also associated with a first logical storage area, which may be a logical storage area associated with, integrated with, coupled to, or connected to the computer system 120. Such logical storage areas may be or represent account data. Such logical storage areas may include data of various types and the nature of the data will depend on the nature of the computer system 120.

The computer system 120 may be a computer server system. A computer server system may, for example, be a mainframe computer, a minicomputer, or the like. In some implementations thereof, a computer server system may be formed of or may include one or more computing devices. A computer server system may include and/or may communicate with multiple computing devices such as, for example, database servers, computer servers, and the like. Multiple computing devices such as these may be in communication using a computer network and may communicate to act in cooperation as a computer server system. For example, such computing devices may communicate using a local-area network (LAN). In some embodiments, a computer server system may include multiple computing devices organized in a tiered arrangement. For example, a computer server system may include middle tier and back-end computing devices. In some embodiments, a computer server system may be a cluster formed of a plurality of interoperating computing devices. Additionally or alternatively, a computer server system may be a plurality of computing devices engaged in cloud computing.

In some embodiments, the computer system 120 may be coupled to, connected with, associated with, or integrated with a database or another storage medium. The computer system 120 may store in the database, data received from or data generated in association with the client system 110. Additionally or alternatively, data received from or data generated in association with the client system 110 may be stored in a logical storage area or logical storage areas maintained in the database. The database or storage medium may be provided in secure storage. The secure storage may be provided internally or externally. The secure storage may include one or more data centers. The data centers may, for example, store data with bank-grade security. In at least some implementations, the database or storage medium may be a cloud-based datastore.

The computer system 120 may include a generative function module that may be engaged to generate or output values or parameters via a generative function. Examples of generative functions include without limitation generative artificial intelligence models and generative artificial intelligence chat boxes.

The computer system 120 may include an image processing module that may be engaged to convert image data of text into machine-encoded or machine-readable text. The conversion of image data to machine-encoded or machine-readable text may use techniques such as optical character recognition (OCR). In some embodiments, the image processing module may be considered an OCR module.

The computer system 120 may have software or hardware programming for managing, minimizing, or optimizing resource loss associated with the client system 110. For example, the computer system 120 may be configured to run a software program for determining an appropriate time, time period, or time frame for the client system 110 to run, execute, or undergo a network security update. In another example, the computer system 120 may be configured to run a software program for determining an appropriate time, time period, or time frame for the client system 110 to transfer computer data or a computer resource to another computer system.

The network 130 may be a computer network. In some embodiments, the network 130 may be an internetwork such as may be formed of one or more interconnected computer networks. For example, the network 130 may be or may include an Ethernet network, an asynchronous transfer mode (ATM) network, a wireless network, a telecommunications network, or the like. In some embodiments, the client system 110 and the computer system 120 may send and receive instructions or data to and from each other via the network 130. In some embodiments, the client system 110 may send data, such as security data, loss function data, and image data to the computer system 120 via the network 130. In some embodiments, image data sent from the client system 110 to the computer system 120 may represent a loss function or resource loss function. In some embodiments, instructions sent from the computer system 120 to the client system 110 may cause the client system 110 to execute or perform a computing operation at a particular time. Examples of such computing operations include without limitation system updates and data or resource transfers.

The client system 110 and the computer system 120 may be in geographically disparate locations. Put differently, the client system 110 and the computer system 120 may be remote from one another.

FIG. 1 illustrates an example representation of components of the system 100. The system 100 can, however, be implemented differently than the example of FIG. 1. For example, various components that are illustrated as separate systems in FIG. 1 may be implemented on a common system. By way of further example, the functions of a single component may be divided into multiple components.

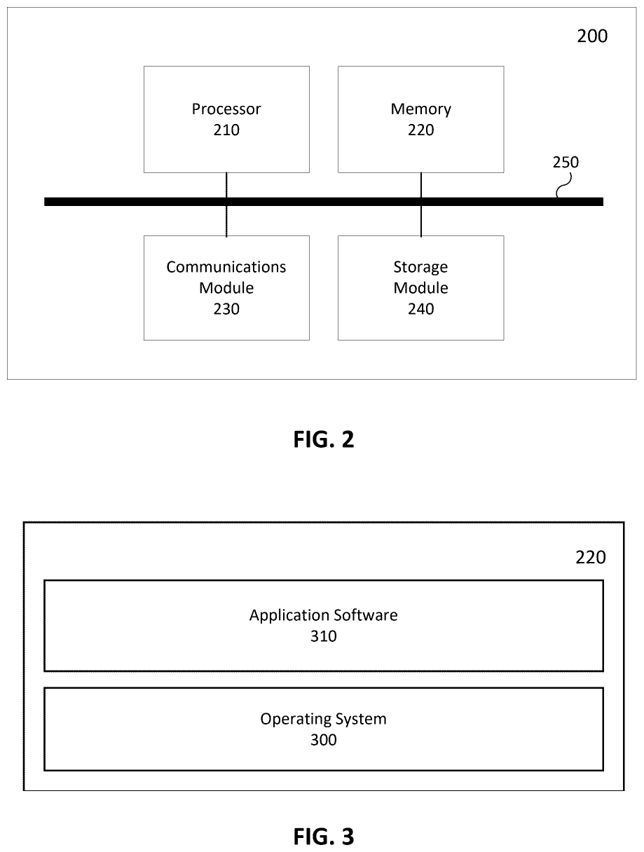

FIG. 2 is a high-level operation diagram of an example computer system 200. In some embodiments, the computer system 200 may be exemplary of the computer system 120 (see FIG. 1).

The example computer system 200 includes a variety of modules. For example, as illustrated, the computer system 200 may include one or more processors 210, a memory 220, a communications module 230, and a storage module 240. As illustrated, the foregoing example modules of the example computer system 200 are in communication over a bus 250.

The one or more processor 210 may be hardware processors. The one or more processors 210 may, for example, be one or more ARM, Intel x86, PowerPC processor or the like.

The memory 220 allows data to be stored and retrieved. The memory 220 may include, for example, random access memory, read-only memory, and persistent storage. Persistent storage may be, for example, flash memory, a solid-state drive, or the like. Read-only memory and persistent storage are a non-transitory computer-readable storage medium. A computer-readable medium may be organized using a file system such as may be administered by an operating system governing overall operation of the example computer system 200.

The communications module 230 allows the example computer system 200 to communicate with other computer or computing devices and/or various communications networks. For example, the communications module 230 may allow the example computer system 200 to send or receive communications signals. Communications signals may be sent or received according to one or more protocols or according to one or more standards. For example, the communications module 230 may allow the example computer system 200 to communicate via a cellular data network, such as for example, according to one or more standards such as, for example, Global System for Mobile Communications (GSM), Code Division Multiple Access (CDMA), Evolution Data Optimized (EVDO), Long-term Evolution (LTE) or the like. Additionally or alternatively, the communications module 230 may allow the example computer system 200 to communicate using near-field communication (NFC), via Wi-Fi™, using Bluetooth™ or via some combination of one or more networks or protocols. In some embodiments, all or a portion of the communications module 230 may be integrated into a component of the computer system 200. For example, the communications module may be integrated into a communications chipset. In some embodiments, the communications module 230 may be omitted such as, for example, if sending and receiving communications is not required in a particular application.

The storage module 240 allows the computer system 200 to store and retrieve data. In some embodiments, the storage module 240 may be formed as a part of the memory 220 and/or may be used to access all or a portion of the memory 220. Additionally or alternatively, the storage module 240 may be used to store and retrieve data from persisted storage other than the persisted storage (if any) accessible via the memory 220. In some embodiments, the storage module 240 may be used to store and retrieve data in a database. A database may be stored in persisted storage. Additionally or alternatively, the storage module 240 may access data stored remotely such as, for example, as may be accessed using a local area network (LAN), wide area network (WAN), personal area network (PAN), and/or a storage area network (SAN). In some embodiments, the storage module 240 may access data stored remotely using the communications module 230. In some embodiments, the storage module 240 may be omitted and its function may be performed by the memory 220 and/or by one or more the processors 210 in concert with the communications module 230 such as, for example, if data is stored remotely. The storage module may also be referred to as a data store.

Software comprising instructions is executed by the one or more processors 210 from a computer-readable medium. For example, software may be loaded into random-access memory from persistent storage of the memory 220. Additionally or alternatively, instructions may be executed by the processor 210 directly from read-only memory of the memory 220.

FIG. 3 depicts a simplified organization of software components stored in the memory 220 of the example computer system 200 (see FIG. 2). As illustrated, these software components include an operating system 300 and application software 310.

The operating system 300 is software. The operating system 300 allows the application software 310 to access the one or more processors 210, the memory 220, and the communications module 230 of the computer system 200 (see FIG. 2). The operating system 300 may be, for example, Google™ Android™, Apple™ iOS™, UNIX™, Linux™, Microsoft™ Windows™, Apple OSX™ or the like.

The application software 310 adapts the computer system 200 (see FIG. 2), in combination with the operating system 300, to operate as a device performing a particular function. For example, the application software 310 may cooperate with the operating system 300 to adapt a suitable embodiment of the computer system 200 to operate as the computer system 120 (see FIG. 1).

The application software 310 may include one or more applications. That is, in operation the memory 220 may include more than one application and different applications may perform different operations. For example, in at least some embodiments in which the computer system 200 is functioning as the computer system 120 (see. FIG. 1), the application software 310 may include 1) an application for configuring the computer system 120 to receive application programming interface requests from the client system 110 (see. FIG. 1), 2) an OCR application for converting image data of text into machine-encoded or machine-readable text, 3) a generative artificial intelligence application for identifying, generating, or determining a loss function, and 4) a scheduling application or resource management application for scheduling or managing computing operations.

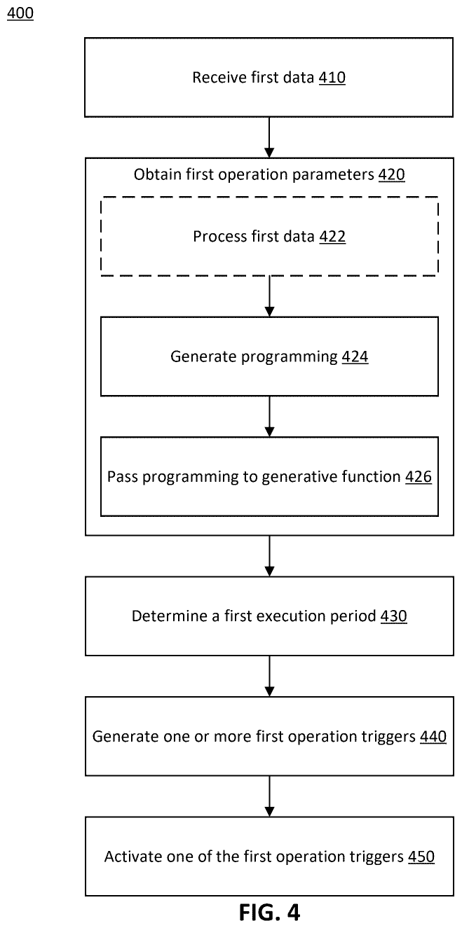

Reference is now made to FIG. 4 which shows, in flowchart form, an example method 400 for managing, minimizing, or optimizing a resource loss associated with a computing operation. The method 400 may be implemented by a computing system such as the computer system 120 (see. FIG. 1). For example, a software module may be configured to cause the computer system 120 to implement the method 400. The method 400 may be performed, for example, by a processor, such as one of the one or more processors 210 (see FIG. 2), of a computer system executing software comprising instructions such as may be stored in a memory or non-transitory memory such as the memory 220 (see FIG. 2). More particularly, processor-executable instructions may, when executed, configure the processor of the computer system to perform all or parts of the method 400 or a portion thereof.

In performing the method 400, the computer system, such as the computer system 120, may cooperate with other systems and devices such as, for example, the client system 110 (see FIG. 1). Each of these other systems and devices may be configured with processor-executable instructions which cause such systems and devices to perform methods which cooperate with the method 400.

The method 400 begins with an operation 410. At the operation 410, the processor or the computer system receives first data representing a first assignment of a first computing operation. In some embodiments, the processor or the computer system may receive the first data from a client system such as the client system 110 (see FIG. 1) and the first computing operation may be a computing operation associated with the client system. For example, the first computing operation may be a system update for the client system. In another example, the first computing operation may be a data transfer or resource transfer from the client system to another system, potentially another client system. In another example, the first computing operation may be a database operation with respect to a logical storage area such as a payment.

In some embodiments, the first computing operation may be associated with a resource loss. For example, if the first computing operation is a system update to the client system, executing the first computing operation may cause a loss of access to the client system for the duration of the system update. In another example, if the first computing operation is a transfer of single-instance data from the client system to another system, executing the first computing operation may cause the loss of access to the transferred data. In yet another example, the first computing operation may represent a transfer of resources. The first computing operation may, in some implementations, be or include a database operation.

In some embodiments, the first data may be machine-encoded or machine readable. In other embodiments, at least some of the first data may represent information that is not machine-encoded or machine readable. For example, the first data may include image data. The image data may be, for example, a joint photographic experts group (JPEG) or portable document format (PDF) file of a photograph of a document containing instructions to perform or execute the first computing operation. For example, the document may be a physical or paper document instructing an entity associated with the client system to transfer data from or associated with the client system to another system. Examples of such documents include, without limitation, operation protocols, operation policies, instruction manuals, contracts, and invoices. Additionally or alternatively, an image of the document may be have been captured by an image capturing device associated with, connected to, operatively connected to, or integrated with the client system. Additionally or alternatively, a paper document instructing the entity to transfer the data may have been scanned to the client system via a scanner associated with, connected to, operatively connected to, or integrated with the client system. Additionally or alternatively, the first data may be scanned data that the processor receives directly from a scanner associated with the client system.

Following the operation 410, flow control may proceed to an operation 420. At the operation 420, the processor obtains one or more first operation parameters, the one or more first operation parameters being associated with the first computing operation. The operation 420 may include a suboperation 422, a suboperation 424, and a suboperation 426.

The suboperation 422 may be optional. At the suboperation 422, the processor may process the first data to be compliant or suitable for a particular computational process. For example, in the event that the first data is image data representing textual instructions, such as, for example, operation protocols, operation guidelines, instruction manuals, contracts, or invoices, the processor may execute OCR techniques, systems, methods, algorithms, or programming to convert the image data into machine-readable data. Additionally or alternatively, the processor may use OCR techniques to extract machine-readable data from the image data.

At the suboperation 424, the processor may generate programming for a generative function. The programming may be considered instructions to provide to a generative function executed on the computer system. Additionally or alternatively, the programming may be considered a prompt to input into a generative function wherein the generative function outputs the one or more first operation parameters.

In some embodiments, the programming may cause the generative function to output a due date or deadline, a time that the first computing operation was assigned to the client system, a minimum performance of the first computing operation that is required (for example, a minimum amount to update a system by or a minimum amount of data to transfer to another system), data indicative of a loss or loss function associated with performing or executing the first computing operation, data indicative of a loss or loss function associated with failing to perform or execute the first computing operation, a rank, grade, or value indicative of the severity of failing to perform or execute the first computing operation, or a combination thereof. In some embodiments, the rank, grade, or value, may be on a scale. The scale may, for example, be on a scale of 1-10 wherein 1 represents a minimum severity and 10 represents a maximum severity. The grades may be discrete values on the scale. In other embodiments, the rank, grade, or value may take on a value or quantity in a spectrum. For example, the rank, grade, or value may be any real number between 0 and 1 inclusive wherein 0 represents a minimum severity and 1 represents a maximum severity. In some embodiments, the rank, grade, or value may not be a number. For example, the rank, grade, or value may be on a scale of A-D wherein A represents a maximum severity and D represents a minimum severity.

In some embodiments, the programming may follow a specific or predefined format. For example, the programming may follow a template with fields wherein the fields can be filled in based on the first data. In some embodiments, the programming may follow a predefined format wherein the predefined format is one of a plurality of predefined formats. For example, the computer system may store, in a storage medium, a plurality of templates for different kinds of computing operations. For example, the computer system may have a template for system updates and another template for data transfers. The processor may determine from or based on the first data that the first computing operation is of a particular kind or type of computing operation. The processor may then select an appropriate template or predefined format to structure the programming. In yet further embodiments, the processor may generate the programming without following a specific or predefined format or template. For example, the first data may include a portion of the programming and the processor may be configured to extract the portion of the programming included in the first data from the first data. In yet additional embodiments, the processor may generate the programming based on input. For example, an operator of the computer system may provide, at least a portion of the programming, to the computer system via an input interface such as a keyboard. In another example, an operator of the client system may generate at least a portion of the programming and send that portion of the programming to the computer system.

In some embodiments, the programming may be in a programming language such as, without limitation, C++, Java, Javascript, or Python. For example, the programming may be a Python script. In other embodiments, the programming may be in a human-readable language. For example, the programming may include textual prompts. Examples of textual prompts include without limitation “provide due date of system update,” “provide minimum amount of system update required,” “provide consequences of failing to update system,” “rank consequence of failing to update system,” “provide deadline of data transfer,” “provide minimum data transfer required,” “provide consequences of failing to transfer data,” “rank consequence of failing to transfer data,” and “rank consequence of failing to transfer data on a scale of 1-10.”

In some embodiments, the programming may include at least a portion of the first data. For example, the programming may be a template with fields that are filled in with data extracted or identified from the first data.

At the suboperation 426, the processor may pass or input the programming to a generative function. That is, the processor may provide the programming to the generative function, the programming being at least partially based on the first data. The generative function may be implemented by software or computer programming elements. Examples of a generative function include without limitation a generative artificial intelligence program or model. Upon receiving the programming, the generative function may output the first operation parameters. That is, the processor may receive output from the generative function. In some embodiments, the output of the generative function may include the first operation parameters.

In some embodiments, the generative function may be a generative artificial intelligence model that has been trained to, at least, rank, grade, or evaluate a degree of severity of failing to perform or execute the first computing operation. In some embodiments, the generative function may be trained using paired data wherein each pair comprises data representing a computing operation and data representing a rank or grade. In other embodiments, training data used to train the generative function may include a list of items of data representing computing operations wherein the items are sorted from least severe consequence of non-performance to greatest severe consequence of non-performance, or vice versa.

In some embodiments, the generative function may have OCR capabilities. In these embodiments, some of the first data may be directly incorporated into the programming generated at the suboperation 424 even if the first data is image data depicting text. That is, the suboperation 422 may be considered a part of or merged with the suboperation 426.

In some embodiments, the one or more first operation parameters may include a first loss function or data defining or representing a first loss function. The first loss function may be considered a function that outputs a loss or resource loss associated with performing or executing the first computing operation. Inputs to the first loss function may include without limitation a time or time period for performing or executing the first computing operation and an amount of completion of the first computing operation consequent to performing or executing the first computing operation at the inputted time or during the inputted time period. That is, the first loss function may have a first time-based input variable.

In an example scenario for the operation 420, the first computing operation may be a system update and the first data may be represented by the following table.

| | |
|---|---|
| Computing operation type: | System update |
| Required by: | 01:00, Jan. 1^{st}, 2025 |
| Resultant loss: | No access for 24 hours |
| Consequence of failure: | Vulnerability to network attacks |
| Minimum update threshold: | Server A |
| Resultant loss of minimum update: | No access for 6 hours |

In this example scenario, at the suboperation 424, the processor may generate programming represented by or akin to the following pseudocode.

find(data=first_data, field=“due date”);
find(data=first_data, field=“loss”, perform=TRUE);
find(data=first_data, field=“loss”, perform=FALSE);
find(data=first_data, field=“minimum performance”);
find(data=first_data, field=loss, perform=”minimum performance”);
eval(data=first_data, perform=FALSE);
eval(data=first_data; perform=”minimum performance”);

In another embodiment, but in the same example scenario, at the suboperation 424, the processor may generate programming represented by or akin to the following text.
“Find the following in the attached data file: 1) a due date, 2) resource loss from the computing operation, 3) consequences of failing to execute the computing operation, 4) a minimum performance requirement, 5) resource loss associated with the minimum performance requirement, 6) a rank for the severity of not executing the computing operation,” and 7) a rank for the severity of only executing the minimum performance.”

In this example scenario, upon receiving the programming, the generative function may output data reflective of the righthand column in the table above. In an embodiment of this example scenario, the generative function may provide outputs represented by or akin to the following:

{“due date”: 2025-01-01-0100, “loss”: [“yes”: 24, “no”:
“s-100”, “minimum”: [6, “s-40”]], “minimum”:
”Server A”, rank: 8}

In the example output above, in “s-100” and “s-40,” “s” may indicate a security vulnerability and “100” and “40” may indicate a degree of the security vulnerability. Further, 24 and 6 may indicate time, in hours, that the system is unavailable due to the system update. Further, “rank” may indicate, represent, or reflect a degree of severity arising from not executing the computing operation (i.e. the system update in this example).

Further, in this example scenario, it may be considered that the generative function has output a first loss function wherein inputting the time corresponding to Dec. 1, 2024 at 1:00 a.m. outputs a loss of 24 hours. While in this particular example scenario, time does not appear to affect the resource loss associated with performing or executing the first computing operation, in other example scenarios, the resource loss may be time-dependent. For example, in another example scenario, failing to update the client system by 1:00 a.m. on Jan. 1, 2025 may cause a system update occurring afterwards to take longer. For example, updating the client system at 1:00 a.m. on Jan. 2, 2025 may cause the client system to be unavailable for 36 hours instead of 24 hours. In another example scenario, say a data transfer from the client system to another system, failing to perform, execute, or complete the data transfer by a particular time for a particular result may cause additional data to be transferred to the another system to obtain or achieve the same particular result.

Following the operation 420, flow control may proceed to the operation 430. At the operation 430, the processor may determine, based on the one or more first operation parameters, a first execution period for the first computing operation to be at least partially executed.

Using the example scenario from before, at the operation 420, the processor may determine that the client system should perform, execute, or run a system update (the first computing operation) on December 31, 2024 at 1:00 a.m. Additionally or alternatively, depending on the situation, the processor may determine that the client system should partially perform, execute, or run the first computing operation on December 31, 2024 at 6:00 a.m. and then perform, execute, or run the remainder of the first computing operation after midnight on January 1, 2025. This situation may arise, for example, if an operator of the client system needs to use the client system between December 31, 2024, 1:00 a.m. and January 1, 2025, 1:00 a.m. Additionally or alternatively, the processor may determine, due to use requirements for the client system, to not perform or execute the first computing operation until after January 1, 2025 at 12:00 a.m. and suffer the consequence of a more vulnerable security system for an extended period.

In some embodiments, to determine the first execution period, the processor may determine a first resource loss by passing at least a first time in the first execution period to the first loss function. For example, the processor may pass data representing the time period of December 31, 2024, 1:00 a.m. to the first loss function from the above-described example scenario. Passing December 31, 2024, 1:00 a.m. may result in the first loss function outputting data representing 24 hours. That is, 24 hours may be considered the first resource loss in this example scenario. After determining the first resource loss, in some embodiments, the processor may determine that incurring the first resource loss results in a resource quantity exceeding a resource threshold. The resource threshold may be considered an amount of resource (for example, access to the client system or data) that the client system requires access to at a particular time. Returning to the above-described example scenario, if the client system needs to be used from, for example, 3:00 a.m. to 4:00 a.m. on Dec. 31, 2024, the resource threshold for that particular time period may be considered a value or quantity representing access to or availability of the client system. On the other hand, if there is no need to access the client system during the same, the resource threshold for that particular time period may be considered a value or quantity representing no access to or no availability of the client system. Alternatively, the resource threshold for that particular time period may be considered a value or quantity representing a “negative” access to or a “negative” availability of the client system. Hence, incurring the first resource loss during the time period between 3:00 a.m. and 4:00 a.m. may result in a first resource quantity (no access) that “exceeds” the resource threshold (“negative” access). In another example such as a data transfer or resource transfer, the resource threshold may be a condition that the client system maintain a particular quantity of data with, stored in, or associated with the client system. In some embodiments, if incurring the first resource loss associated with a particular time or time period results in a resource quantity failing to exceed a resource threshold, the processor may determine a different time period to perform or execute the first computing operation.

In some embodiments, determining the first execution may further comprise determining a plurality of execution periods to execute, at least partially, the first computing operation and the first execution period may be one of the plurality of execution periods. Using the example scenario of a system update, the processor may determine 1) a first execution period corresponding to 6:00 a.m. to 12:00 p.m. on Dec. 31, 2024 for a partial update of the client system and 2) a second execution period for updating the remainder of the client system.

In some embodiments, determining the first execution period may further comprise 1) determining a second computing operation associated with a second loss function; and 2) determining the first execution period based on the second loss function. For example, the client system may be tasked with a first computing operation involving a first data transfer and a second computing operation involving a second data transfer. Both data transfers may result in a loss of resource and may have corresponding loss functions (a first loss function and a second loss function). In this example, the computer system may be configured to schedule the data transfers so that the client system is able to suffer the first resource loss (calculated via the first loss function) without compromising the client system's ability to suffer the second resource loss (calculated by the second loss function), or vice versa. An example in which the client system's ability to suffer the second resource loss is compromised is, for example, if suffering the first resource loss at a particular time depletes the resource to an extent that the there is not enough of the resource to incur the second resource loss by a particular date. For example, after suffering the first resource loss, a resource amount associated with the client system may be less than the second resource loss.

In some embodiments, the processor may use artificial intelligence such as generative artificial intelligence to perform or execute the determination in the operation 430.

Following the operation 430, flow control may proceed to an operation 440. At the operation 440, the processor may generate one or more first operation triggers. A trigger may, for example, be a condition defined by data stored in a memory that when satisfied, causes the processor to execute an operation such as the first computing operation or an operation, auxiliary operation, or task associated with the first computing operation. For example, the trigger generated in the operation 440 may, when satisfied or triggered, cause the processor to send or transmit a notification to the client system to initiate or activate the first computing operation. An example condition for a trigger is time. For example, a trigger may cause the processor to execute particular instructions at a particular time such as the first execution period. In some embodiments, the processor may generate multiple triggers. For example, the processor may generate a trigger for sending or transmitting a notification related to the first computing operation to the client system and another trigger for activating or initiating the first computing operation. In some embodiments, a first operation trigger may be considered to be defined by a condition relative to the first execution period.

Using the example scenario from before, if the processor determined that the client system should partially perform, execute, or run the first computing operation on December 31, 2024 at 6:00 a.m. and then perform, execute, or run the remainder of the first computing operation after midnight on January 1, 2025, the processor may generate a trigger that would cause the client system to run the partial system update on December 31, 2024 at 6:00 a.m. Additionally or alternatively, the processor may generate a trigger that would cause the processor to send the following message to the client system on December 31, 2024 at 5:00 a.m.
“System update to be automatically run in one hour from now. Please prepare system for update by 5:55 a.m.”

Following the operation 440, flow control may proceed to an operation 450. At the operation 450, the processor may activate, initiate, or trigger one of the one or more first operation triggers. In some embodiments, the processor may trigger one of the one or more first operation triggers during the first execution period. Additionally or alternatively, the processor may detect that a condition associated with one of the one or more triggers is satisfied. For example, the processor may detect that a current time is now within the first execution period or is a time associated with the first computing operation. In response to triggering the one of the one or more first operation triggers, or detecting satisfaction of a condition associated with the one of the one or more first operation triggers, the processor may execute or perform, at least partially, the first computing operation. Using the example scenario from before, triggering one of the one or more first operation triggers may cause the processor to transmit instructions to the client system at 6:00 a.m. on December 31, 2024 wherein the instructions cause the client system to run a partial system update. Alternatively, triggering one of the triggers may cause the processor to transmit instructions to the client system at 1:00 a.m. on December 31, 2024 wherein the instructions cause the client system to run a full system update.

In some embodiments, the first computing operation may be associated with a client device and triggering the one of the one or more first operation triggers may cause the processor to request, from the client device, authorization to execute, at least partially, the first computing operation. In some embodiments, the client device may be the client system. In other embodiments, the client device may be a device associated with the client system. Using the example scenario involving a system update for a client system, a client device may be a separate computing device of a handler, user, operator, or manager of the client system. Triggering one of the one or more first operation triggers may cause the processor to transmit the following message to this client device on December 31, 2024 at 5:55 a.m.
“Partial system update scheduled at 6:00 a.m. Please confirm that the system update may execute as scheduled.”

The above message may be displayed on a user interface on the client device and the user interface may provide a mechanism for the user, handler, operator, or manager to provide approval for the system update. For example, the user interface may have a swiping bar wherein swiping right causes the system update to proceed as scheduled and swiping left cancels the scheduled system update. Additionally or alternatively, the user interface may provide a “Yes” and “No” button that when clicked respectively causes the scheduled system update to proceed or cancels the scheduled system update.

In some embodiments, one of the first operation triggers may be triggered prior to the first execution period and the triggering may cause the processor to send, to an associated client device, a notification that the first computing operation is to be executed, at least partially, during the first execution period. Using the example scenario involving a system update for a client system, triggering one of the one or more first operation triggers may cause the processor to transmit the following message to a separate client device of an operator of the client system on December 31, 2024 at 5:55 a.m.
“Partial system update to be executed 6:00 a.m.”

In some embodiments, the first computing operation may be one of a series of computing operations and the processor may be further configured to determine, based on operation data associated with at least one of the series of computing operations, a next execution period for a next computing operation to be at least partially executed. For example, the computer system or processor may detect that the client system is subject to a 24 hour system update every 3 months. In response to detecting this pattern, the computer system may be configured to tentatively schedule a system update on the first Sunday of January, April, July, and October. Consequent to tentatively scheduling the system updates, the processor may schedule other computing operations associated with the client system such that these other computing operations do not interfere with the client system updates and vice versa. In another example, the computer system or processor may detect that the client system performs a data transfer from the client system to another system by the same amount or resource amount on the 15^{th} day of each month. In response to detecting this pattern, the computer system may be configured to tentatively schedule a data transfer by the resource amount on the 15^{th} of each month. Consequent to tentatively scheduling the data transfers, the computer system may be configured to schedule other data transfers (not necessarily periodic) such that these other data transfers do not interfere with the scheduled period data transfers or vice versa. In some implementations, the first computing operation may be a database operation such as a database operation associated with a transfer.

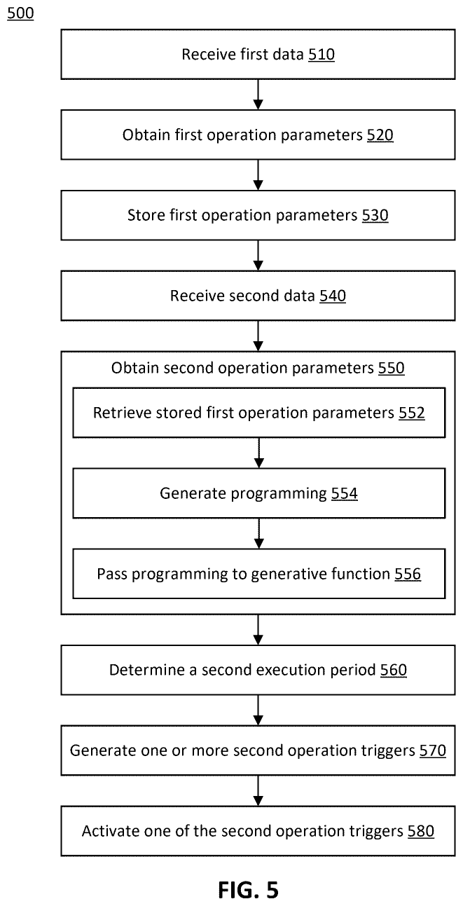

Reference is now made to FIG. 5 which shows, in flowchart form, another example method 500 for managing, minimizing, or optimizing a resource loss associated with a computing operation. In particular, the method 500 relates to managing, minimizing, or optimizing resource loss associated with a second computing operation related to or associated with a first computing operation. For example, the first and second computing operations may be data transfers from the client system to a common receiving system. The method 500 may be implemented by a computing system such as the computer system 120 (see. FIG. 1). For example, a software module may be configured to cause the computer system 120 to implement the method 500. The method 500 may be performed, for example, by a processor, such as one of the one or more processors 210 (see FIG. 2), of a computer system executing software comprising instructions such as may be stored in a memory or non-transitory memory such as the memory 220 (see FIG. 2). More particularly, processor-executable instructions may, when executed, configure the processor of the computer system to perform all or parts of the method 500 or a portion thereof.

In performing the method 500, the computer system, such as the computer system 120, may cooperate with other systems and devices such as, for example, the client system 110 (see FIG. 1). Each of these other systems and devices may be configured with processor-executable instructions which cause such systems and devices to perform methods which cooperate with the method 500.

The method 500 begins with an operation 510. At the operation 510, the processor or the computer system receives first data representing a first assignment of a first computing operation. The operation 510 may be considered similar or parallel to the operation 410 (see FIG. 4) and the description of the operation 410 of in the present application may be applicable to the operation 510.

Following the operation 510, flow control may proceed to an operation 520. At the operation 520, the processor obtains one or more first operation parameters, the one or more first operation parameters being associated with the first computing operation. The operation 520 may be considered similar or parallel to the operation 420 (see FIG. 4) and the description of the operation 420 in the present application may be applicable to the operation 520.

Following the operation 520, flow control may proceed to an operation 530. At the operation 530, the processor may store, in a storage medium, at least one of the one or more first operation parameters. For example, if the first computing operation is a data transfer from the client system to another system, one of the parameters may be a portion of data defining a first loss function associated with the first computing operation wherein the portion of data defines a mechanism that causes the first loss function to output greater loss as time passes. This one of the parameters may be stored in a storage medium in association with the first computing operation. Additionally or alternatively, this one of the parameters may be stored in association with another parameter. For example, in the case of a data transfer from the client system to another system, the another system may have an address (virtual, physical, or otherwise). In this example, the processor may store data defining at least a portion of the first loss function in association with the address of the another system.

In some embodiments, the processor may generate an identifier for the first computing operation and associate the identifier with the first computing operation. The processor may then store the at least one of the one or more first operation parameters in association with the identifier. Additionally or alternatively, the processor may generate an identifier for one of the first operation parameters and store another one of the first operation parameters in association with the identifier. For example, in the case of a data transfer from the client system to another system, the processor may generate an identifier for the another system or an address (physical, virtual, or otherwise) of the another system. The processor may then store at least a portion of data defining the first loss function in a storage medium in association with the identifier.

Following the operation 530, flow control may proceed to an operation 540. At the operation 540, the processor or the computer system receives second data representing a second assignment of a second computing operation. In some embodiments, this second computing operation may be related or associated with the first computing operation. For example, the first and second computing operations may both involve a data transfer from the client system to another or second system.

Following the operation 540, flow control may proceed to an operation 550. At the operation 550, the processor obtains one or more second operation parameters, the one or more second operation parameters being associated with the second computing operation. In some embodiments, the operation 550 may execute in response to the operation 540. That is, the processor may obtain the second operation parameters in response to receiving the second data. The operation 550 may include a suboperation 552, a suboperation 554, and a suboperation 556.

At the suboperation 552, the processor may retrieve, from the storage medium, the at least one of the one or more first operation parameters stored in the storage medium (see operation 530).

At the suboperation 554, the processor may generate programming for a generative function. The programming may be considered instructions to provide to a generative function executed on the computer system. Additionally or alternatively, the programming may be considered a prompt to input into a generative function wherein the generative function outputs the one or more second operation parameters.

In some embodiments, the programming may cause the generative function to output a due date or deadline, a time that the second computing operation was assigned to the client system, a minimum performance of the second computing operation that is required (for example, a minimum amount to update a system by or a minimum amount of data to transfer to another system), data indicative of a loss or loss function associated with performing or executing the second computing operation, data indicative of a loss or loss function associated with failing to perform or execute the second computing operation, a rank, grade, or value indicative of the severity of failing to perform or execute the second computing operation, or a combination thereof. In some embodiments, the rank, grade, or value, may be on a scale. The scale may, for example, be on a scale of 1-10 wherein 1 represents a minimum severity and 10 represents a maximum severity. The grades may be discrete values on the scale. In other embodiments, the rank, grade, or value may take on a value or quantity in a spectrum. For example, the rank, grade, or value may be any real number between 0 and 1 inclusive wherein 0 represents a minimum severity and 1 represents a maximum severity. In some embodiments, the rank, grade, or value may not be a number. For example, the rank, grade, or value may be on a scale of A-D wherein A represents a maximum severity and D represents a minimum severity.

In some embodiments, the programming may follow a specific or predefined format. For example, the programming may follow a template with fields wherein the fields can be filled in based on the second data. In some embodiments, the programming may follow a predefined format wherein the predefined format is one of a plurality of predefined formats. For example, the computer system may store, in a storage medium, a plurality of templates for different kinds of computing operations. For example, the computer system may have a template for system updates and another template for data transfers. The processor may determine from or based on the second data that the second computing operation is of a particular kind or type of computing operation. The processor may then select an appropriate template or predefined format to structure the programming. In yet further embodiments, the processor may generate the programming without following a specific or predefined format or template. For example, the second data may include a portion of the programming and the processor may be configured to extract the portion of the programming included in the second data from the second data. In yet additional embodiments, the processor may generate the programming based on input. For example, an operator of the computer system may provide, at least a portion of the programming, to the computer system via an input interface such as a keyboard. In another example, an operator of the client system may generate at least a portion of the programming and send that portion of the programming to the computer system.

In some embodiments, the programming may be in a programming language such as, without limitation, C++, Java, Javascript, or Python. For example, the programming may be a Python script. In other embodiments, the programming may be in a human-readable language. For example, the programming may include textual prompts. Examples of textual prompts include without limitation “provide due date of system update,” “provide minimum amount of system update required,” “provide consequences of failing to update system,” “rank consequence of failing to update system,” “provide deadline of data transfer,” “provide minimum data transfer required,” “provide consequences of failing to transfer data,” “rank consequence of failing to transfer data,” and “rank consequence of failing to transfer data on a scale of 1-10.”

In some embodiments, the programming may include at least a portion of the second data. For example, the programming may be a template with fields that are filled in with data extracted or identified from the second data.

In some embodiments, the processor may generate the programming based on the retrieved at least one of the one or more first operation parameters. For example, one of the stored first operation parameters may be a portion of data defining a first loss function associated with the first computing operation wherein the portion of data defines a mechanism that causes the first loss function to output greater loss as time passes. In this example, in obtaining the second operation parameters, the processor may be configured to use or consider the stored first operation parameters as also defining a part of a second loss function associated with the second computing operation wherein the part of the second loss function corresponds to a mechanism that causes the second loss function to output greater loss as time passes. Thus, the programming may not include a command, script, request, or prompt, for obtaining the same parameter from the second data. This may cause the generative function to operate more efficiently as the generative function may engage in less computing or processing.

At the suboperation 556, the processor may pass or input the programming to a generative function. That is, the processor may provide the programming to the generative function, the programming being at least partially based on the second data. The generative function may be implemented by software or computer programming elements. Examples of a generative function include without limitation a generative artificial intelligence program or model. Upon receiving the programming, the generative function may output the second operation parameters. That is, the processor may receive output from the generative function. In some embodiments, the output of the generative function may include the second operation parameters.

In some embodiments, the generative function may be a generative artificial intelligence model that has been trained to, at least, rank, grade, or evaluate a degree of severity of failing to perform or execute the first computing operation. In some embodiments, the generative function may be trained using paired data wherein each pair comprises data representing a computing operation and data representing a rank or grade. In other embodiments, training data used to train the generative function may include a list of items of data representing computing operations wherein the items are sorted from least severe consequence of non-performance to greatest severe consequence of non-performance, or vice versa.

In some embodiments, the generative function or processor may check the output of the generative function, or one of the outputted second operation parameters, against one of the stored or retrieved first operation parameters to check or increase accuracy of the generative function. For example, the first computing operation and second computing operation may both relate to periodic data transfers of a fixed amount of a data resource. In such a case, the amount of the data resource transferred may be considered a first operation parameter and it may be stored in association with the first computing operation. Upon outputting the second operation parameters, the processor may check that the outputted second operation parameter corresponding to the amount of data resource being transferred is equal to the first computing operating parameter for the same. Additionally or alternatively, the processor may check that the second outputted second operation parameter corresponding to the amount of data resource being transferred is within an expected range given the first computing operating parameter for the same.

In some embodiments, the generative function may have OCR capabilities. In these embodiments, some of the second data may be directly incorporated into the programming generated at the suboperation 554 even if the second data is image data depicting text. That is, the suboperation 552 may be considered a part of or merged with the suboperation 556.

In some embodiments, the one or more second operation parameters may include a second loss function or data defining or representing a second loss function. The second loss function may be considered a function that outputs a loss or resource loss associated with performing or executing the second computing operation. Inputs to the second loss function may include without limitation a time or time period for performing or executing the second computing operation and an amount of completion of the second computing operation consequent to performing or executing the second computing operation at the inputted time or during the inputted time period. That is, the second loss function may have a second time-based input variable.

Taken together, the suboperations 552, 554, and 556 may be interpreted as the processor identifying one or more second operation parameters wherein at least one of the second operation parameters is identified by retrieving the at least one of the stored one or more first operation parameters. Additionally or alternatively, the suboperation 552, 554, and 556 may be interpreted as the processor identifying one or more second operation parameters via the output of a generative function and checking or testing the output against stored first operation parameters.

Following the operation 550, flow control may proceed to an operation 560. At the operation 560, the processor may determine, based on the one or more second operation parameters, a second execution period for the first computing operation to be at least partially executed. The operation 560 may be considered similar or parallel to the operation 430 (see FIG. 4).

Following the operation 560, flow control may proceed to an operation 570. At the operation 570, the processor may generate one or more second operation triggers. The operation 570 may be considered similar or parallel to the operation 440 (see FIG. 4).

Following the operation 570, flow control may proceed to an operation 580. At the operation 580, the processor may activate or initiate one of the second operation triggers. The operation 580 may be considered similar or parallel to the operation 450 (see FIG. 4).

In some embodiments, the operations 510 and 520 may be the same as the operations 410 and 420 (see FIG. 4). Following the operation 520, the processor may also execute or perform another thread of operation executing at least partially concurrently with the operations 530 to 580. This concurrent thread may correspond to the operations 430 to 450 (see FIG. 4).

Example embodiments of the present application are not limited to any particular operating system, system architecture, mobile device architecture, server architecture, or computer programming language.

It will be understood that the applications, modules, routines, processes, threads, or other software components implementing the described method/process may be realized using standard computer programming techniques and languages. The present application is not limited to particular processors, computer languages, computer programming conventions, data structures, or other such implementation details. Those skilled in the art will recognize that the described processes may be implemented as a part of computer-executable code stored in volatile or non-volatile memory, as part of an application-specific integrated chip (ASIC), etc.

As noted, certain adaptations and modifications of the described embodiments can be made. Therefore, the above discussed embodiments are considered to be illustrative and not restrictive.

1. A computer system comprising:
at least one processor; and
a memory coupled to the at least one processor and storing processor-executable instructions which, when executed by the at least one processor, configure the at least one processor to:
receive first data representing a first assignment of a first computing operation;
obtain one or more first operation parameters by:
providing programming to a generative function, the programming being at least partially based on the first data; and
receiving output from the generative function, the output including the first operation parameters;
determine, based on the one or more first operation parameters, a first execution period for the first computing operation to be at least partially executed; and
generate one or more first operation triggers, one of the one or more first operation triggers being defined by a condition relative to the first execution period.

2. The computer system of claim 1 wherein the one or more first operation parameters include a first loss function, the first loss function having a first time-based input variable.

3. The computer system of claim 2 wherein determining the first execution period further comprises:
determining a first resource loss by passing at least a first time in the first execution period to the first loss function; and
determining that incurring the first resource loss results in a resource quantity exceeding a resource threshold.

4. The computer system of claim 1 wherein determining the first execution period further comprises:
determining a second computing operation associated with a second loss function; and
determining the first execution period based on the second loss function.

5. The computer system of claim 1 wherein the instructions further configure the processor to:
trigger one of the one or more first operation triggers during the first execution period; and
execute at least partially, in response to triggering the one of the one or more first operation triggers, the first computing operation.

6. The computer system of claim 1 wherein the first computing operation is associated with a client device and the instructions further configure the processor to:
trigger one of the one or more first operation triggers during the first execution period; and
request from the client device, in response to triggering the one of the one or more first operation triggers, authorization to execute, at least partially, the first computing operation.

7. The computer system of claim 1 wherein the first computing operation is associated with a client device and the instructions further configure the processor to:
trigger, prior to the first execution period, one of the one or more first operation triggers; and
send to the client device, in response to triggering the one of the one or more first operation triggers, a notification that the first computing operation is to be executed, at least partially, during the first execution period.

8. The computer system of claim 1 wherein determining the first execution period further comprises determining a plurality of execution periods to execute, at least partially, the first computing operation, the first execution period being one of the plurality of execution periods.

9. The computer system of claim 1 wherein the first computing operation is associated with an identifier and the instructions further configure the at least one processor to store, in a storage medium, at least one of the one or more first operation parameters.

10. The computer system of claim 9 wherein the instructions further configure the at least one processor to:
receive second data representing a second assignment of a second computing operations associated with the identifier; and
identify, in response to receiving the second data, one or more second operation parameters, at least one of the second operation parameters being identified by retrieving the at least one of the one or more first operation parameters.

11. The computer system of claim 1 wherein the first computing operation is one of a series of computing operations and the instructions further configure the processor to determine, based on operation data associated with at least one of the series of computing operations, a next execution period for a next computing operation to be at least partially executed.

12. The computer system of claim 1 wherein the generative function is a generative artificial intelligence model.

13. A computer-implemented method comprising:
receiving first data representing a first assignment of a first computing operation;
obtaining one or more first operation parameters by:
providing programming to a generative function, the programming being at least partially based on the first data; and
receiving output from the generative function, the output including the first operation parameters;
determining, based on the one or more first operation parameters, a first execution period for the first computing operation to be at least partially executed; and
generating one or more first operation triggers, one of the one or more first operation triggers being defined by a condition relative to the first execution period.

14. The computer-implemented method of claim 13 wherein the one or more first operation parameters include a first loss function, the first loss function having a first time-based input variable.

15. The computer-implemented method of claim 14 wherein determining the first execution period further comprises:
determining a first resource loss by passing at least a first time in the first execution period to the first loss function; and
determining that incurring the first resource loss results in a resource quantity exceeding a resource threshold.

16. The computer-implemented method of claim 13 wherein determining the first execution period further comprises:
determining a second computing operation associated with a second loss function; and
determining the first execution period based on the second loss function.

17. The computer-implemented method of claim 13 wherein the first computing operation is associated with an identifier and the method further comprises storing, in a storage medium, at least one of the one or more first operation parameters.

18. The computer-implemented method of claim 17 wherein the method further comprises:
receiving second data representing a second assignment of a second computing operations associated with the identifier; and
identifying, in response to receiving the second data, one or more second operation parameters, at least one of the second operation parameters being identified by retrieving the at least one of the one or more first operation parameters.

19. The computer-implemented method of claim 13 wherein the first computing operation is one of a series of computing operations and the method further comprises determining, based on operation data associated with at least one of the series of computing operations, a next execution period for a next computing operation to be at least partially executed.

20. A non-transitory computer-readable storage medium comprising processor-executable instructions which, when executed by at least one processor, configure the at least one processor to:
receive first data representing a first assignment of a first computing operation;
obtain one or more first operation parameters by:
providing programming to a generative function, the programming being at least partially based on the first data; and
receiving output from the generative function, the output including the first operation parameters;
determine, based on the one or more first operation parameters, a first execution period for the first computing operation to be at least partially executed; and
generate one or more first operation triggers, one of the one or more first operation triggers being defined by a condition relative to the first execution period.
